(19) United States
(12) Patent Application Publication
(10) Pub. No.: US 2012/0121970 A1
(43) Pub. Date: May 17, 2012

(54) BATTERY STORAGE CASE AND ELECTRONIC DEVICE

(75) Inventor: Daisuke KOZAI, Kanagawa-ken (JP)

(73) Assignee: KABUSHIKI KAISHA KENWOOD, Hachiouji-shi (JP)

(21) Appl. No.: 13/049,257

(22) Filed: Mar. 16, 2011

(30) Foreign Application Priority Data
Nov. 16, 2010 (JP) 2010-256206
Dec. 6, 2010 (JP) 2010-271440

(51) Int. Cl. H01M 2/30; H01M 2/02

(52) U.S. Cl. 429/179; 429/178

(57) ABSTRACT

A battery storage case includes: a case body having a storage section capable of having a battery accommodated therein; and a contact terminal attached to the storage section to be in contact with a positive or negative electrode of the battery to be stored in the storage section. The contact terminal includes: a spiral spring portion including a plurality of turns from a first turn which is located on the side of an inner surface of the case body to a final turn which is located on the side of the electrode of the battery; and an extension extending from the end of the final turn, wherein, as seen in a first plane orthogonal to the axis of the spiral spring portion, the extension extends through about the axis of the spiral spring portion such that the tip of the extension is located outside the final turn.

### CROSS REFERENCE TO RELATED APPLICATIONS

This application claims priority based on 35 USC 119 from prior Japanese Patent Application No. 2010-271440 filed on Dec. 6, 2010, entitled “BATTERY STORAGE CASE AND ELECTRONIC DEVICE” and prior Japanese Patent Application No. 2010-256206 filed on Nov. 16, 2010, entitled “BATTERY STORAGE CASE”, the entire contents of which are incorporated herein by reference.

### BACKGROUND OF THE INVENTION

1. Field of the Invention

The invention relates to a battery storage case and an electronic device capable of accommodating therein a dry-cell battery or a rechargeable battery, and relates especially to an improvement of the shape of the tip of a contact terminal to be in contact with an electrode of the battery.

2. Description of Related Art

Conventionally, an electronic device is equipped with a battery storage case to have one or more batteries accommodated therein and is energized by the one or more batteries in the battery storage case. The battery storage case includes therein a positive contact terminal, which is a contact terminal that is to be in contact with the positive electrode of the battery, and a negative contact terminal, which is a contact terminal that is to be in contact with the negative electrode of the battery. In an example of such a battery storage case, the positive Contact terminal is a fixed terminal designed to deform to a small extent or not to deform while the negative contact terminal is formed in a spiral-spring shape to elastically deform to a large extent. Since the negative contact terminal is formed in the spiral-spring shape, the negative contact terminal pushes the battery toward the positive contact terminal in the battery storage case so that the battery is fixed in the battery storage case.

Upon removing the battery from the battery storage case, the user pushes the battery toward the negative contact terminal to elastically deform the negative contact terminal thereby making a space between the positive electrode of the battery and the positive contact terminal and lifts up the positive end portion of the battery to remove the battery from the battery storage case. However, the user may remove the battery from the battery storage case by lifting the negative end portion of the battery without regard to the orientation of the positive and negative electrodes of the battery. In such a case where the battery is removed from the battery storage case at the negative end portion of the battery, the tip of the spiral-spring shaped negative contact terminal may get stuck with a surface of the negative electrode of the battery.

If the tip of the negative contact terminal gets stuck with the surface of the negative electrode, the negative contact terminal may be deformed, cut a coating of the battery, come off the battery storage case, or damage the battery storage case in some situations. To solve such problems, Japanese Patent Application Laid-Open No. 11-45692 discloses a battery storage case wherein the shape of the tip of the negative contact terminal is improved. Specifically, the tip of the negative contact terminal is bent toward the base of the negative contact terminal.

### SUMMARY OF THE INVENTION

The improved shape of the tip of the negative contact terminal disclosed in Japanese Patent Application Laid-Open No. 11-45692 decreases the possibility that the tip of the negative contact terminal will get stuck with the surface of the negative electrode of the battery to some extent. However, the tip of the negative contact terminal disclosed in Japanese Patent Application Laid-Open No. 11-45692 may get stuck with the surface of the negative electrode of the battery depending on the method of removing the battery. Thus, an improvement of the shape of the tip of the negative contact terminal is required.

To meet such requirement, an object of an aspect of the invention is to provide a battery storage case and an electronic device capable of significantly reducing the possibility that the tip of a spiral contact terminal gets stuck with an electrode of the battery even when the battery is removed from the battery storage case by lifting the end portion of the battery corresponding to the spiral contact terminal.

To solve the problems, an aspect of the invention provides a battery storage case including: a case body having a storage section capable of having a battery accommodated therein; and a contact terminal attached to the storage section to be in contact with the positive or negative electrode of the battery to be stored in the storage section. The contact terminal includes: a spiral spring portion including a plurality of turns from a first turn which is located on the side of the inner surface of the case body to a final turn which is located on the side of the electrode of the battery; and an extension extending froth the end of the final turn, wherein, in a first plane seen toward the first turn side from the final turn side, the extension extends through a center portion of the circular coil shape formed by the plurality of turns such that the tip of the extension is located outside the final turn.

The tip of the extension may be located at a position shifted from the final turn toward the first turn side, as seen in a second plane orthogonal to the first plane.

The extension may curve convexly toward the electrode.

The extension may extend toward the bottom side of the case body from the opening side of the case body.

Another aspect of the invention provides an electronic device including: a housing; a storage recess formed in the housing to accommodate therein a battery; and a contact terminal attached to the storage recess to be in contact with the positive or negative electrode of the battery to be stored in the storage recess. The contact terminal includes: a spiral spring portion including a plurality of turns from a first turn which is located on the side of the inner surface of the storage recess to a final turn which is located on the side of the electrode of the battery; and an extension extending from the end of the final turn, wherein, in a first plane seen from the final turn side toward the first turn side, the extension extends through the center portion of a circular coil shape formed by the plurality of turns such that the tip of the extension is located outside the final turn.

According to the aspects, even when the battery is removed from the battery storage case by lifting the end portion of the battery corresponding to the spiral spring terminal, the possibility that the tip of the spiral contact terminal gets stuck with the electrode of the battery is significantly reduced. This reduces the possibility of a deformation of the spiral contact terminal, damage of a coating on the battery, or the like.

### BRIEF DESCRIPTION OF THE DRAWINGS

FIG. 1 is a perspective view of a battery storage case according to a first embodiment of the invention.

FIG. 2 is a perspective view illustrating a state where lead wires are disconnected from a case body of the battery storage case shown in FIG. 1.

FIG. 3 is a perspective view of one of the lead wires of the first embodiment.

FIG. 4 is a top view of the lead wire of the first embodiment.

FIG. 5 is a side view of the lead wire of the first embodiment.

FIG. 6 is a side view of a spiral-spring-shaped negative contact terminal of the first embodiment.

FIG. 7 is a sectional view of the spiral-spring-shaped negative contact terminal of the first embodiment.

FIGS. 8A and 8B are partial sectional views for explaining the functional effect of the negative contact terminal of the first embodiment.

FIG. 9 is a perspective view of an electronic device according to a second embodiment of the invention.

### DETAILED DESCRIPTION OF EMBODIMENTS

Descriptions are provided herein below for embodiments based on, the drawings. In the respective drawings referenced herein, the same constituents are designated by the same reference numerals and duplicate explanation concerning the same constituents is omitted. All of the drawings are provided to illustrate the respective examples only.

### First Embodiment

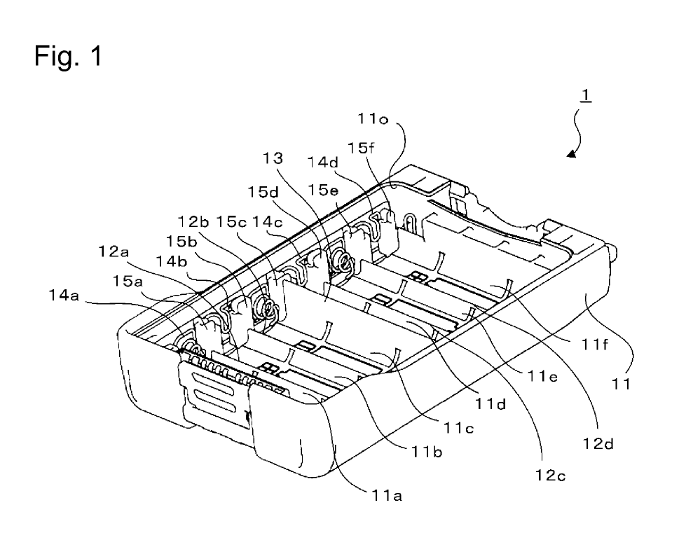

A battery storage case according to a first embodiment of the invention will be described with reference to the drawings. As shown in FIG. 1, battery storage case 1 of the first embodiment has case body 11, which is formed in a rectangular shape and has an opening 11o at the upper side thereof. As an example, case body 11 is formed with six storage sections 11a to 11f for having batteries accommodated therein so that case body 11 can accommodate therein unillustrated six batteries in this embodiment. The battery to be accommodated in case body 11 is a dry-cell battery or a rechargeable battery that has the same or similar shape to the dry-cell battery. The size of the battery may be D, C, AA, AAA, N battery or the like.

Rib-like small projections 12a, 12b, 12c, and 12d, extending along the longitudinal direction of storage section 12a to 12g (or the battery stored in case body 11), are formed between storage sections 11a and 11b, between storage sections 11b and 11c, between storage sections lid and 11e, and between storage sections 11e and 11f, respectively. Also, wall-like projection 13, extending along the longitudinal direction of storage section 11a to 11g and projecting to about the highest point of the battery where the battery is set in case body 11, is formed between storage sections 11 and 11d. Since case body 11 has projections 12a to 12d and 13, six batteries are positioned in case body 12 well.

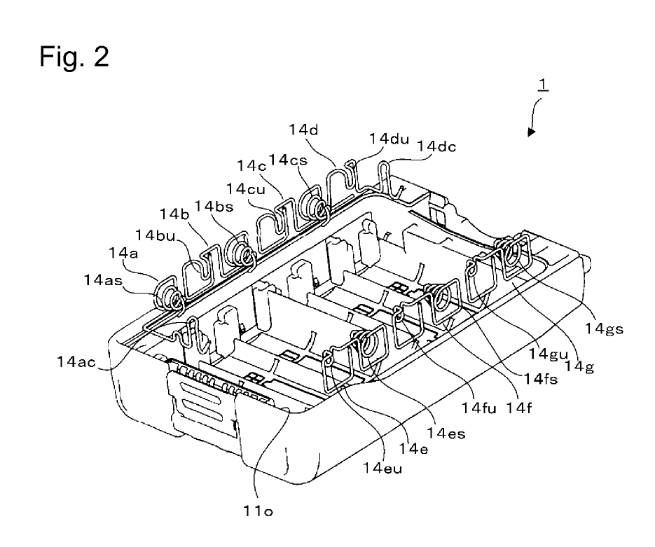

Case body 11 has two long sides opposite to each other and short sides opposite to each other, and the electrodes of the batteries face the long sides of the case body. An inner surface of one (far side in FIG. 1) of the long sides is formed with catches 15a to 15f to catch lead wires 14a to 14d. An inner surface, which cannot be seen in FIG. 1, of the other (near side in FIG. 1) of the long sides of case body 11 is formed with catches that are the same or similar to catches 15a to 15f, to which lead wires 14e to 14g shown in FIG. 2 are connected respectively.

Next, lead wires 14a to 14g will be described with reference to FIG. 2. Lead wires 14a to 14g are formed into predetermined shapes respectively by bending and/or winding conductive spring wire materials. Lead wire 14a has a spiral-spring-shaped negative contact terminal (spiral spring portion) 14as, which is to be in contact with the negative electrode of the battery. Note that in lead wires 14b to 14g, a contact terminal having a spiral-spring shape is a negative contact terminal, which is to be in contact with the negative electrode of the battery. Lead wire 14b has U-shaped positive contact terminal 14bu to be in contact with the positive electrode of the battery and the spiral-spring-shaped negative contact terminal 14bs to be in contact with the negative electrode of the battery. Note that in lead wires 14c to 14g, a contact terminal having a U-shape is a positive contact terminal, which is to be in contact with the positive electrode of the battery.

Lead wire 14c is formed in the same shape as lead wire 14b and thus has U-shaped positive contact terminal 14cu and spiral-spring-shaped negative contact terminal 14cs. Lead wire 14d has U-shaped positive contact terminal 14du. Lead wires 14e, 14f, and 14g have the same shape and have U-shaped positive contact terminal 14eu, 14fu, and 14gu and spiral-spring-shaped negative contact terminal 14es, 14fs, and 14gs, respectively.

As will be appreciated from FIG. 2, six batteries are stored in storage sections 11 to lit in case body 11 such that orientations of adjacent batteries are reversed with respect to each other regarding their polarities. The six batteries accommodated in case body 11 are in contact with lead wires 14a to 14g and thus are serially-connected. Open side 11o of case body 11 is to be covered by an un-illustrated lid. Provided at the inner surface of the lid are a terminal (not shown) to be in contact with contact portion 14ac of lead wire 14a and a terminal (not shown) to be in contact with contact portion 14dc of contact terminal 14d. The electric power of the series-connected six batteries is supplied to the terminals provided at the inner surface of the lid. Provided at the outer surface of the lid are terminals to be in contact with the power supply terminals of an electronic device to which battery storage case 1 is attached. Thus, the electric power is supplied to the power supply terminals of the electronic device via the terminals provided at the inner surface of the lid and the terminals provided at the outer surface of the lid.

Battery storage case 1 of the embodiment is only an example. A battery storage case of the invention maybe able to accommodate only one battery for example, in other words, the invention does not limit the number of batteries that the battery storage case can accommodate therein. In the case where the battery storage case can accommodates therein plural batteries, the plural batteries may be serial-connected or parallel-connected. The embodiment is characterized by the shape of the spiral-spring-shaped negative contact terminals 14as to 14gs of lead wires 14a to 14g; the portions other than negative contact terminal in the lead wire may be arbitrarily-configured or arbitrarily-shaped. For example, positive contact terminals 14bu to 14gu may be formed in a shape other than the U-shape and may be formed in the same shape as the negative contact terminal, for example.

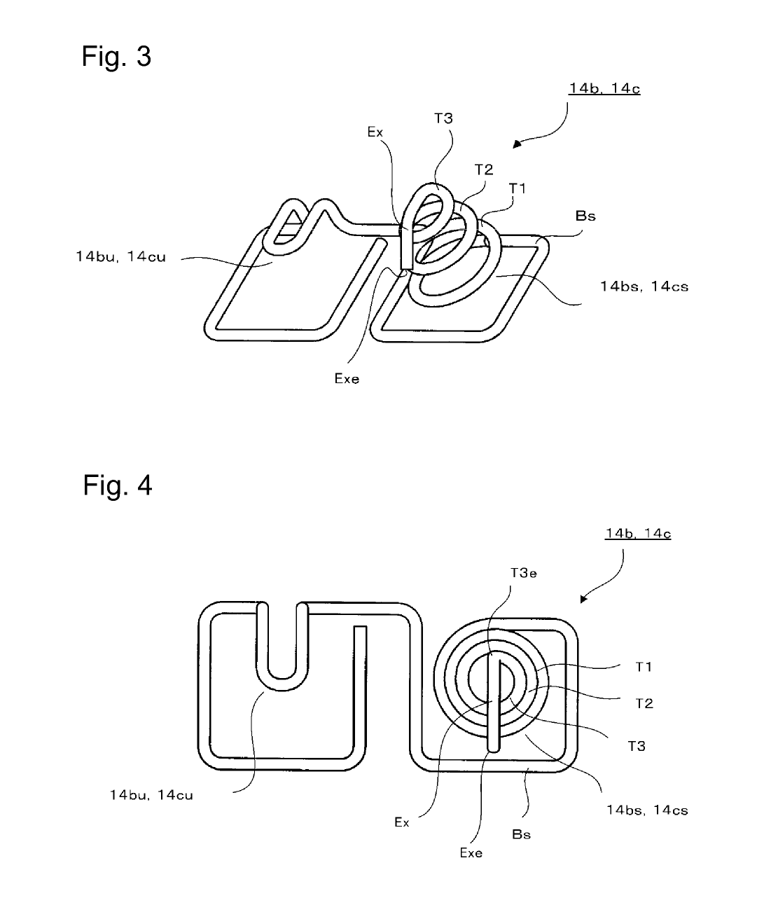

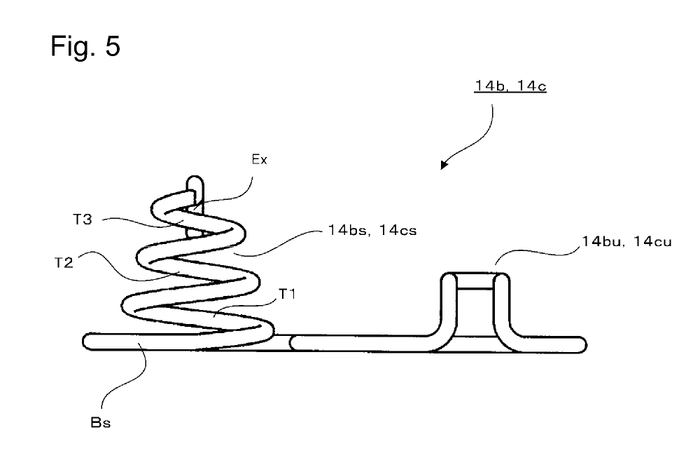

Next, the detail configurations of negative contact terminal 14as to 14gs will be described with reference to FIGS. 3 to 7. In FIGS. 3 to 5, lead wire 14b or 14c is shown as representative of lead wires 14a to 14g. FIG. 3 is a perspective view of lead wire 14b or 14c. FIG. 4 is a top view of lead wire 14b or 14c. FIG. 5 is a side view of lead wire 14b or 14c. As shown in FIGS. 3 to 5, spiral-spring-shaped negative contact terminals 14bs or 14cs continue from substantially-rectangular base portion Bs. Negative contact terminal 14bs or 14cs has a spiral spring portion comprising first to third turns T1, T2, and T3 whose diameters decrease in that order. Turn T1 is the first turn and turn T3 is the third turn, which is the final turn in this embodiment. Note that the number of the turns of the negative contact terminal is not limited to three in the invention.

As shown in FIG. 4, negative contact terminal 14bs or 14cs has extension Ex which extends from and is bent at end point T3e of third turn T3. As seen in the first plane orthogonal to the axis of the spiral spring portion, extension Ex extends through an area around the axis of the spiral spring portion comprising first turn T1 to third turn T3. In other words, as seen in the first plane viewed from third turn T3 to first turn T1 of negative contact terminal 14bs or 14cs, extension Ex extends through the center portion of a substantially circular coil shape formed by first turn T1 to third turn T3. Note that the center portion of the circular coil shape is not limited to the exact center thereof (or the axis) but is an area having a predetermined width around the exact center. The length of extension Ex is greater than the diameter of third turn T3 as seen in the first plane. Tip Exe of extension Ex is located outside third turn T3 as seen in the first plane. Tip Exe of extension Ex is formed from a cut surface of the spring wire material.

Endpoint T3e between third turn T3 and extension Ex is illustrated sharply bent in FIG. 4, however, it is gently bent in practice as shown in FIG. 3. It should be understood that end point T3e may be sharply bent as shown in FIG. 4. As shown in FIG. 3, in this embodiment, extension Ex extends in a curved line, and tip Exe of extension Ex extends toward the side of first turn T1 (toward the side of base portion Bs). Extension Ex should be formed such that at least tip Exe thereof is located outside third turn T3 in the first plane; extension Ex may be straight in the invention. Like the embodiment, it is preferred that extension Ex extends in a curved line such that tip Exe of extension Ex inclines toward the first turn (T1) side.

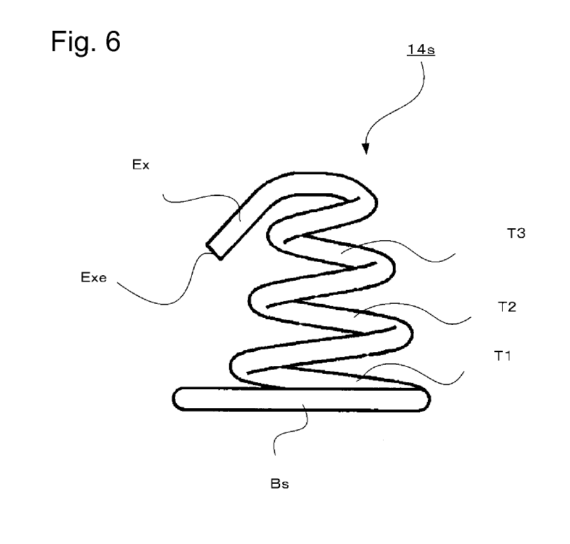

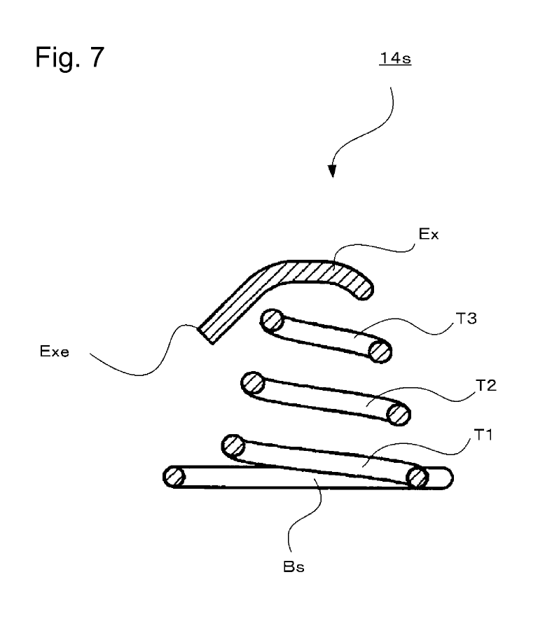

Next, with reference to FIGS. 6 and 7, the shape of extension Ex will be described in more detail. Spiral-spring-shaped negative contact terminal 14as to 14gs of lead wires 14a to 14g will be referred to as negative contact terminal 14s. FIGS. 6 and 7 illustrate a normal state where negative contact terminal 14s (the spiral spring portion) is not pushed by the battery. FIG. 6 is a side view of negative contact terminal 14s and FIG. 7 is a sectional view of negative contact terminal 14s, sectioned along extension Ex.

As shown in FIGS. 6 and 7, as seen in a second plane orthogonal to the first plane, it is preferred that extension Ex curves convex to above negative contact terminal 14s, that is, extension Ex curves convex to the negative electrode of the battery such that tip Exe inclines toward the first turn (T1) side. Further, it is preferred that tip Exe of extension Ex is located at a position shifted toward first turn T1 (base portion Bs) from third turn T3 serving as the final turn. Tip Exe extends to a position (height) between third turn T3 and second turn T2 in this embodiment; however, tip Exe may extend to a position (height) of second turn T2 or to a position (height) between second turn T2 and base portion Bs.

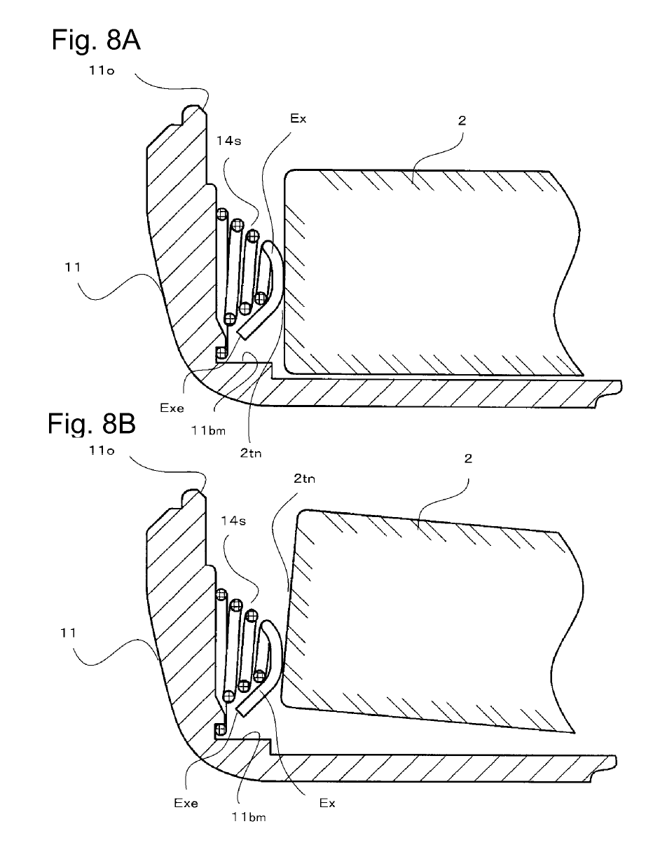

Next, the functional effect of negative contact terminal 14s having the described characteristic configuration of this embodiment will be described with reference to FIGS. 8A and 8B. FIG. 8A illustrates the state where battery 2 is stored in one of storage sections 11a to 11f. Note that FIG. 8A and 8B illustrate only a negative end portion of battery 2, which is an end portion of battery 2 in which negative electrode 2tn is formed. Negative electrode 2tn is in contact with extension Ex of negative contact terminal 14s. In this state, negative contact terminal 14s is compressed by battery 2. With this, tip Exe reaches the position (height) of second turn T2. Note that the surface of the negative electrode 2tn of battery 2 has a projection(s) and a recess(s) in practice; however, it is illustrated as a flat surface to simplify the drawings.

As shown in FIG. 8A, it is preferred that negative contact terminal 14s is attached in case body 11 such that extension Ex extends toward the bottom (11bm) side of case body 11 from the opening (11o) side of case body 11.

FIG. 8B illustrates the state where battery 2 is now being removed from the battery storage case by lifting up the negative end portion of battery 2. Upon lifting the negative end portion of battery 2, extension Ex guides the movement of negative electrode. 2tn of battery 2. As shown in FIG. 8B, in the course of removing battery 2, the surface of the negative electrode of battery 2 slides on extension Ex, and thus the surface of negative electrode 2tn of battery 2 or the corner of battery 2 rarely get stuck with third turn T3. Therefore, battery storage case 1 of this embodiment drastically reduces the possibility that negative contact terminal 14s is deformed, the coating of battery 2 is cut, negative contact terminal 14s comes off battery storage case 1, or battery storage case 1 is damaged.

In the battery storage case of Japanese Patent Application Laid-Open No. 11-45692, the tip of the negative contact terminal is not located outside the final turn as seen in the first plane and the tip of the negative contact terminal is not located at a position shifted from the final turn toward to the first turn side. If negative contact terminal 14s of the embodiment is replaced with that of Japanese Patent Application Laid-Open No. 11-45692, the surface of negative electrode 2tn of battery 2 or the corner of battery 2 may get stuck with the final turn of the negative contact terminal, and thus the described functional effect of the embodiment cannot be obtained. In contrast to Japanese Patent Application Laid-Open No. 11-45692 or the like, this embodiment drastically reduces the possibility that the end portion, such as tip Exe and third turn T3, of negative contact terminal 14s get stuck with the surface of negative electrode 2tn of battery 2 when battery 2 is removed from battery storage case 1 by lifting up the negative end portion of battery 2.

### Second Embodiment

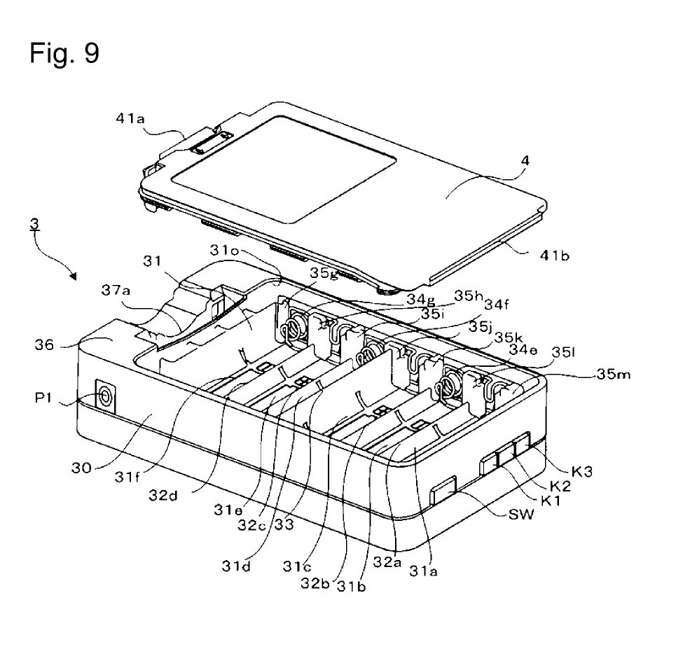

Electronic device 3 serving as the second embodiment of the invention will be described with reference to FIG. 9. In the second embodiment, description of the same configurations as the first embodiment is omitted. In FIG. 9, electronic device 3 according to the second embodiment is, for example, a portable music player. Electronic device 3 includes housing 30, earphone terminal P1 provided at a lateral surface of housing 30, power switch Sw provided at a top surface of housing 30, and operation keys K1 to K3 provided at the top surface of housing 30 to input various operational commands to electronic device 3. Electronic device 3 also includes a display provided at the front surface (not shown) of housing 30, which is a lower side in FIG. 9.

Storage recess 31 to accommodate therein batteries 2 (not shown in FIG. 9) is formed at rear surface 36 of housing 30. Opening end 31o of storage recess 31 is closed by lid 4. One of the short sides of lid 4 is formed with engagement portion 41a, and the other of the short sides of lid 4 is formed with engagement projection 41b. One of the short sides of opening end 31o of housing 30 is formed with engagement portion 37a to be engaged with engagement portion 41a of lid 4, and the other of the short sides of opening end 31o is formed with an unillustrated engagement portion to be engaged with engagement projection 41b. When engagement portion 41a and engagement projection 41b of lid 4 are respectively engaged with engagement portion 37a and the unillustrated engagement portion of housing 30, lid 4 is fixed to housing 30 and covers opening end 31o of housing 30.

The inside structure of storage recess 31 is the same as that of battery storage case 1 of the first embodiment. As shown in FIG. 9, six storage sections 31a to 31f to accommodate therein batteries is formed in storage recess 31. Rib-like small projections 32a, 32b, 32c, and 32d, extending along the longitudinal direction of the battery stored in storage recess 31, are formed between storage sections 31a and 31b, between storage sections 31b and 31c, between storage sections 31d and 31e, and between storage sections 31e and 31f, respectively. Wall-like projection 33, extending along the longitudinal direction of the battery stored in storage recess 31 and projecting to about the highest point of the battery stored in storage recess 31, is formed between storage sections 31c and 31d.

An inner surface of one of the long sides of storage recess 31, which is the sides that are to be opposed to the electrodes of the batteries, is formed with catches 35g to 35m to catch lead wires 34e to 34g. An inner surface (not shown in FIG. 9) of the other long side (near side in FIG. 9) is formed with catches (not shown in FIG. 9), to which lead wires (not shown in FIG. 9) having the same configurations as lead wires 14a to 14d are caught, respectively.

Lead wires 34e to 34g have the same shapes as lead wires 14e to 14g of the first embodiment and thus each lead wire 34e to 34g has a U-shaped positive contact terminal and a spiral-spring-shaped negative contact terminal. The shape of the spiral-spring-shaped negative contact terminal in lead wires 34e to 34g and the lead wires (not shown in FIG. 9) is the same as that of the first embodiment. In the second embodiment, the positive contact terminal may be formed in other shapes than the U-shape and may be formed in the same shape as the spiral-spring-shaped negative contact terminal, for example.

The invention includes other embodiments in addition to the above-described embodiments without departing from the spirit of the invention. The embodiments are to be considered in all respects as illustrative, and not restrictive. The scope of the invention is indicated by the appended claims rather than by the foregoing description. Hence, all configurations including the meaning and range within equivalent arrangements of the claims are intended to be embraced in the invention.

What is claimed is:

1. A battery storage case comprising:
a case body having a storage section capable of having a battery accommodated therein; and
a contact terminal attached to the storage section to be in contact with a positive or negative electrode of the battery to be stored in the storage section,
the contact terminal including:
a spiral spring portion including a plurality of turns from a first turn which is located on the side of the inner surface of the case body to a final turn which is located on the side of the electrode of the battery; and
an extension extending from the end of the final turn, wherein, in a first plane seen toward the first turn side from the final turn side, the extension extends through a center portion of a circular coil shape formed by the plurality of turns such that the tip of the extension is located outside the final turn.

2. The battery storage case according to claim 1, wherein
the tip of the extension is located at a position shifted from the final turn toward the first turn side, as seen in a second plane orthogonal to the first plane.

3. The battery storage case according to claim 1, wherein
the extension curves convexly toward the electrode of the battery.

4. The battery storage case according to claim 1, wherein
the tip of the extension inclines toward the first turn side.

5. The battery storage case according to claim 1, wherein
the case body includes a bottom side and an opening side opposed to the bottom, and
the extension extends toward the bottom side of the case body from the opening side of the case body.

6. An electronic device, comprising:
a housing;
a storage recess formed in the housing to accommodate therein a battery; and
a contact terminal attached to the storage recess to be in contact with a positive or negative electrode of the battery to be stored in the storage recess,
the contact terminal including:
a spiral spring portion including a plurality of turns from a first turn which is located on the side of an inner surface of the storage recess to a final turn which is located on the side of the electrode of the battery; and
an extension extending from the end of the final turn, wherein, in a first plane seen from the final turn side toward the first turn side, the extension extends through a center portion of a circular coil shape formed by the plurality of turns such that the tip of the extension is located outside the final turn.

7. The electronic device according to claim 6, wherein
the tip of the extension is located at a position shifted from the final turn toward the first turn side, in a second plane which is orthogonal to the first plane.

8. The electronic device according to claim 6, wherein
the extension curves convexly toward the electrode of the battery.

9. The electronic device according to claim 6, wherein
the tip of the extension inclines toward the first turn side.

10. The electronic device according to claim 6, wherein
the storage recess is formed with a bottom side and an opening side opposed to the bottom, and
the extension extends toward the bottom side of the storage recess from the opening side of the storage recess.

11. A battery storage case comprising:
a case body having a storage section capable of having a battery accommodated therein; and
a contact terminal attached to the storage section to be in contact with a positive or negative electrode of the battery to be stored in the storage section,
the contact terminal including:
a spiral spring portion including a plurality of turns from a first turn which is located on the side of an inner surface of the case body to a final turn which is located on the side of the electrode of the battery; and
an extension extending from the end of the final turn, wherein, as seen in a first plane orthogonal to the axis of the spiral spring portion, the extension extends through about the axis of the spiral spring portion such that the tip of the extension is located outside the final turn.
